(19) United States
(12) Patent Application Publication
(10) Pub. No.: US 2010/0089752 A1
(43) Pub. Date: Apr. 15, 2010

(54) FUNCTIONALIZATION OF HYDROGEN DEUTERIUM-TERMINATED DIAMOND

(76) Inventors: Matthew R. Linford, Orem, UT (US); Li Yang, Richland, WA (US)

Correspondence Address: JAMES SONNTAG;JAMES SONNTAG, PATENT ATTORNEY, P.O. BOX 9194, SALT LAKE CITY, UT, 84109, US

(21) Appl. No.: 12/564,901

(22) Filed: Sep. 22, 2009

Related U.S. Application Data
(60) Provisional application No. 61/192,842, filed on Sep. 22, 2008.

(51) Int. Cl. B01D 15/08; C01B 31/06; B01D 53/02; B01D 57/02

(52) U.S. Cl. 204/456; 423/415.1; 210/656; 95/88

(57) ABSTRACT

Deuterium and hydrogen terminated diamond surfaces are functionalized with alkyl or aryl peroxide.

### CROSS REFERENCE TO RELATED APPLICATIONS

Priority is claimed from U.S. Provisional Patent Application 61/192,842, filed Sep. 22, 2008, which is hereby incorporated by reference.

### BACKGROUND

Diamond is an extraordinary material because of its remarkable mechanical, thermal, and electrical properties. It also has tremendous chemical stability and inertness, which makes it an attractive material for many applications, including as a sorbent in separations science.^{1,2} Accordingly, there is a need to create coated diamond particles of micron dimensions that might be suitable for solid phase extraction, and ultimately for chromatography.

In an effort to enhance and/or take advantage of some of its already remarkable aspects, there has recently been much interest in functionalizing the surface of diamond. For example, chlorinated diamond reacts with CHF₃³ and NH₃⁴ at elevated temperatures. Fluoronano diamond surfaces react with alkyllithium reagents, diamines, and amino acids in the liquid phase, resulting in methyl-, butyl-, hexyl-, ethylenediamino- and glycine-functionalized nanodiamond derivatives.⁵ Hydrogen- and deuterium-terminated diamond surfaces can be prepared thermally^{6,7} and by plasma treatment.⁸⁻¹¹ Hydrogen-terminated diamond surfaces have also been modified via UV light. For example, hydrogen-terminated diamond can be covalently modified with molecules bearing a terminal vinyl (C═C) group via a photochemical process using sub-band gap light at 254 nm,¹² and other photochemical terminations at varying energies, are also known.¹²⁻¹⁷ Liquid phase functionalizations include the modification of diamond (100) by Diels-Alder chemistry.^{18,19} In addition, plasma modification of diamond surfaces,^{20,21} ultrasonic treatment of acid-washed diamond particles (in this work the authors demonstrate DRIFT of 5-12 μm diamond particles),²² electrochemical methods,²³ such as electrochemical reduction of diazonium salts and Suzuki coupling with acryl organics^{24,25} have been reported.

A key issue associated with functionalization of hydrogen-terminated (HTD) or deuterium-terminated diamond (DTD) is breaking the strong C—H or C-D bond. One successful approach to this problem has been to use radicals in a two-step, Eley-Rideal type mechanism, where a radical's interaction with HTD or DTD may result in hydrogen or deuterium abstraction from the surface, leaving a carbon-centered radical, and a second radical may then condense with the dangling bond to covalently link this radical to the surface. This type of mechanism has been proposed for monolayer formation on hydrogen-terminated silicon.²⁶ In addition, Tsubota and coworkers have used the thermal decomposition of diacyl peroxides either alone or with other species to functionalize HTD through this general mechanism via benzoyl peroxide,²⁷⁻³¹ lauroyl peroxide,²⁹ acetonitrile activated with a diacyl peroxide,³⁰ and benzoyl peroxide with dicarboxylic acids³¹ a or monocarboxylic acid.³²⁻³⁴ They also reported that two dialkyl peroxides, dicumyl peroxide and di-t-buyl peroxide, do not appear to react with HTD to an appreciable extent.²⁹ Their reaction conditions for this chemistry were a small amount of the dialkyl peroxide (0.05 g or 0.2 mL, respectively) in 5 mL of toluene heated to 85° C. for 60 min. Liu³⁵ subsequently claimed that a low concentration of another dialkyl peroxide (di-tert-amylperoxide, DTAP, Scheme 1) (24.5 mg in 50 mL dodecane) would react with HTD at 112° C. for ca. 2 hr. However, the infrared spectrum of his reaction product is not consistent with the occurrence of this reaction.

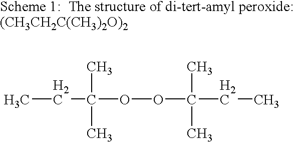

Table of References

| | |
|---|---|
| (1) | Nesterenko, P. N.; Fedyanina, O. N.; Volgin, Y. V. Analyst 2007, 132, 403. |
| (2) | Nesterenko, P. N.; Fedyanina, O. N.; Volgin, Y. V. J. Chromatogr., A 2007, 1155, |
| | 2. |
| (3) | Ando, T.; Nishitani-Gamo, M.; Rawles, R. E.; Yamamoto, K.; Kamo, M.; Sato, Y. |
| | Diamond and Related Materials 1996, 5, 1136. |
| (4) | Miller, J. B.; Brown, D. W. Langmuir 1996, 12, 5809. |
| (5) | Liu, Y.; Gu, Z.; Margrave, J. L.; Khabashesku, V. N. Chem. Mater. 2004, 16, |
| | 3924. |
| (6) | Ando, T.; Ishii, M.; Kamo, M.; Sato, Y. Journal of the Chemical Society, Faraday |
| | Transactions 1993, 89, 1783. |
| (7) | Jiang, T.; Xu, K.; Ji, S. Journal of the Chemical Society, Faraday Transactions |
| | 1996, 92, 3401. |
| (8) | Yang, W.; Butler, J. E.; Russell, J. N., Jr.; Hamers, R. J. Langmuir 2004, 20, |
| | 6778. |
| (9) | Tse, K.-Y.; Nichols, B. M.; Yang, W.; Butler, J. E.; Russell, J. N. J.; Hamers, R. J. |
| | Journal of Physical Chemistry B 2005, 109, 8523. |
| (10) | Wang, S.; Swain, G. M. J. Phys. Chem. C. 2007, 111, 3986. |
| (11) | Kondo, T.; Aoshima, S.; Honda, K.; Einaga, Y.; Fujishima, A.; Kawai, T. J. Phys. |
| | Chem. C. 2007, 111, 12650. |
| (12) | Strother, T.; Knickerbocker, T.; Russell, J. N. J.; Butler, J. E.; Smith, L. M.; |
| | Hamers, R. J. Langmuir 2002, 18, 968. |
| (13) | Ohta, R.; Saito, N.; Inoue, Y.; Sugimura, H.; Takai, O. J. Vac. Sci. Technol. A |
| | 2004, 22, 2005. |
| (14) | Nichols, B. M.; Butler, J. E.; Russell, J. N. J.; Hamers, R. J. Journal of Physical |
| | Chemistry B 2005, 109. |
| (15) | Nakamura, T.; Ishihara, M.; Ohana, T.; Koga, Y. Chemical communications |
| | (Cambridge, England) 2003, 7, 900. |
| (16) | Lasseter, T. L.; Clare, B. H.; Abbott, N. L.; Hamers, R. J. Journal of the American |
| | Chemical Society 2004, 126, 10220. |
| (17) | Nakamura, T.; Suzuki, M.; Ishihara, M.; Ohana, T.; Tanaka, A.; Koga, Y. |
| | Langmuir 2004, 20, 5846. |
| (18) | Wang, G. T.; Bent, S. F.; Russell, J. N. J.; Butler, J. E.; D'Evelyn, M. P. Journal |
| | of the American Chemical Society 2000, 122, 744. |
| (19) | Ouyang, T.; Gao, X.; Qi, D.; Wee, A. T. S.; Loh, K. P. Journal of Physical |
| | Chemistry B 2006, 110, 5611. |
| (20) | Hahn, M.; Pleu, D.; Nitschke, M.; Frens, G.; Bundel, G.; Prause, S.; Simon, F. |
| | Journal of Adhesion Science and Technology 2005, 19, 1039. |
| (21) | Scruggs, B. E.; Gleason, K. K. Journal of Physical Chemistry 1993, 97, 9187. |
| (22) | Visbal, H.; Ishizaki, C.; Ishizaki, K. Journal of the Ceramic Society of Japan |
| | 2004, 112, 95. |
| (23) | Notsu, H.; Yagi, I.; Tatsuma, T.; Tryk, D. A.; Fujishima, A. Electrochem. Solid- |
| | State Lett. 1999, 2, 522. |
| (24) | Yeap, W. S.; Chen, S.; Loh, K. P. Langmuir 2009, 25, 185. |
| (25) | Zhong, Y. L.; Loh, K. P.; Midya, A.; Chen, Z.-K. Chem. Mater. 2008, 20, 3137. |
| (26) | Linford, M. R.; Chidsey, C. E. D. Journal of the American Chemical Society 1993, |
| | 115, 12631. |
| (27) | Tsubota, T.; Hirabayashi, O.; Ida, S.; Nagaoka, S.; Nagata, M.; Matsumoto, Y. |
| | Diamond and Related Materials 2002, 11, 1374. |
| (28) | Tsubota, T.; Hirabayashi, O.; Ida, S.; Nagaoka, S.; Nagata, M.; Matsumoto, Y. |
| | Physical Chemistry Chemical Physics 2002, 4, 806. |
| (29) | Ida, S.; Tsubota, T.; Hirabayashi, O.; Nagata, M.; Matsumoto, Y.; Fujishima, A. |
| | Diamond and Related Materials 2003, 12, 601. |
| (30) | Tsubota, T.; Ida, S.; Hirabayashi, O.; Nagaoka, S.; Nagata, M.; Matsumoto, Y. |
| | Physical Chemistry Chemical Physics 2002, 4, 3881. |
| (31) | Ida, S.; Tsubota, T.; Tanii, S.; Nagata, M.; Matsumoto, Y. Langmuir 2003, 19, |
| | 9693. |
| (32) | Tsubota, T.; Tanii, S.; Ida, S.; Nagata, M.; Matsumoto, Y. Diamond and Related |
| | Materials 2004, 13, 1093. |
| (33) | Tsubota, T.; Tanii, S.; Ida, S.; Nagata, M.; Matsumoto, Y. Hyomen Gijutsu 2003, |
| | 54, 758. |
| (34) | Tsubota, T.; Tanii, S.; Ida, S.; Nagata, M.; Matsumoto, Y. Physical Chemistry |
| | Chemical Physics 2003, 5, 1474. |
| (35) | Liu, Y. S., Brigham Young University, Provo, 2007. |
| (36) | Handbook of Chemistry and Physics, 81 ed.; CRC Press: Boca Raton, 2000. |
| (37) | Ando, T.; Ishii, M.; Kamo, M.; Sato, Y. J. Chem. Soc. Faraday Trans. 1993, 89, |
| | 1783. |
| (38) | Bylaska, E. J.; de Jong, W. A.; Govind, N.; Kowalski, K.; Straatsma, T. P.; Valiev, M.; |
| | Wang, D.; Apra, E.; Windus, T. L.; Hammond, J.; Nichols, P.; Hirata, S.; |
| | Hackler, M. T.; Zhao, Y.; Fan, P.-D.; Harrison, R. J.; Dupuis, M.; Smith, D. M. A.; |
| | Nieplocha, J.; Tipparaju, V.; Krishnan, M.; Wu, Q.; Van Voorhis, T.; Auer, A. A.; |
| | Nooijen, M.; Brown, E.; Cisneros, G.; Fann, G. I.; Fruchtl, H.; Garza, J.; Hirao, K.; |
| | Kendall, R.; Nichols, J. A.; Tsemekhman, K.; Wolinski, K.; Anchell, J.; |
| | Bernholdt, D.; Borowski, P.; Clark, T.; Clerc, D.; Dachsel, H.; Deegan, M.; Dyall, K.; |
| | Elwood, D.; Glendening, E.; Gutowski, M.; Hess, A.; Jaffe, J.; Johnson, B.; |
| | Ju, J.; Kobayashi, R.; Kutteh, R.; Lin, Z.; Littlefield, R.; Long, X.; Meng, B.; |
| | Nakajima, T.; Niu, S.; Pollack, L.; Rosing, M.; Sandrone, G.; Stave, M.; Taylor, H.; |
| | Thomas, G.; van Lenthe, J.; Wong, A.; Zhang, Z., NWChem, A |
| | Computational Chemistry Package for Parallel Computers, Version 5.1.; Pacific |
| | Northwest National Laboratory: Richland, USA, 2007. |
| (39) | Kendall, R. A.; Apra, E.; Bernholdt, D. E.; Bylaska, E. J.; Dupuis, M.; Fann, G. I.; |
| | Harrison, R. J.; Ju, J.; Nichols, J. A.; Nieplocha, J.; Straatsma, T. P.; Windus, T. L.; |
| | Wong, A. T. Computer Phys. Comm. 2000, 128, 260. |

### SUMMARY

An aspect is a method of coating a diamond surface comprising:

terminating the surface with hydrogen or deuterium;

reacting the hydrogen or deuterium-terminated diamond particle with a dialkyl or diaryl peroxide. The peroxide can be represented as,

R—O—O—R′

where R and R′ are the same or different, R and R′ are alkyl or aryl, and where neither or one is hydrogen. The reacting is under conditions that will provide a sufficient temperature to decompose the peroxide into fragments and sufficient for reaction to proceed. In general, this would be above a threshold of about 95° C. In addition, the concentration of the peroxide must be high enough for the reaction to proceed. This is unlike previous attempts, where either or both the reaction temperature and the concentration of the peroxide were insufficient.

An aspect is a diamond particle with a chemically modified with a dialkyl or diaryl peroxide, so that the diamond particle has a surface of a dialkyl or diaryl peroxide. The surface is applied on hydrogen terminated diamond surfaces and before applying the coating the diamond particle the surface is treated to create hydrogen terminated sites on the surfaces before modification with the peroxide.

An aspect is a method of coating a diamond particle comprising; a. hydrogen or deuterium terminating the surface of the diamond particle b. Reacting the hydrogen or deuterium-terminated diamond particle with a dialkyl or diaryl peroxide. The two group on the dialkyl or diaryl may be the same or different. As an example, the dialkyl or diaryl peroxide can be described as:

R—O—O—R′

The groups R and R′ in the peroxide are the same or different, and R and R′ are alkyl or aryl groups. Either one of R or R′, but not both, may be hydrogen. In addition, either one or both of R and R′ may contain elements besides carbon and hydrogen. Exemplary groups include, but are not limited to, linear alkyl chains, methyl group, ethyl groups, isopropyl groups, an isobutyl groups.

Another aspect is a method of coating a diamond particle comprising heating a diamond particle in the presence of a dialkyl or diaryl peroxide above the decomposition temperature of the dialkyl or diaryl peroxide. The diamond particle surface may be terminated with hydrogen or deuterium.

Another aspect is a method of conducting a chromatographic separation comprising passing an analyte through a stationary phase comprising diamond particles modified with a dialkyl or diaryl peroxide. Chromatography, as used herein, involves any separation involving interaction between an analyte and a surface on a stationary phase that can lead to separation of one analyte from another. Examples of chromatographic methods include high performance liquid chromatography (HPLC), ultra high performance liquid chromatography (UPLC), solid phase extraction, gas chromatography, electrochromatography, and the various separations that can and do occur in microfluidic devices.

Another aspect is a method of preparing a thick coating on a diamond particle comprising repeatedly exposing the diamond particle to a dialkyl or diaryl peroxide that has been heated above the decomposition temperature of the peroxide.

Another aspect of the invention is the modification of a planar diamond surface or other object containing diamond comprising
a. Hydrogen or deuterium terminating the surface of the diamond object,
b. Reacting the hydrogen or deuterium-terminated diamond object with a dialkyl or diaryl peroxide.

Functionalization of hydrogen- and deuterium-terminated diamond with DTAP has been accomplished. Dialkylperoxide can react with diamond. HTD and DTD that are heated with neat DTAP at higher temperatures or at least higher concentrations than were previously investigated. This is a one-step modification of hydrogen- and deuterium-terminated diamond using a radical producing species. The reaction is believed to proceed via an Eley-Rideal type mechanism.
(1) Radicals are first created by the thermolysis of DTAP at its weak O—O bond.
(2) Simple thermodynamics suggests that the O—H bond is stronger than the C—H bond³⁶ so these oxygen-centered radicals should abstract hydrogen or deuterium from diamond surfaces, yielding carbon-centered radicals.
(3) Surface functionalization then takes place by condensation of surface radicals with peroxy radicals. X-ray photoelectron spectroscopy (XPS), diffuse reflectance Fourier transform infrared spectroscopy (DRIFT) and time of flight secondary ion mass spectroscopy (ToF-SIMS), and density functional theory provide evidence for this surface reaction.

(CH₃CH₂(CH₃)₂CO)₂ [symbol] 2.OC(CH₃)₂CH₂CH₃ (1)

Diamond-(H or D)+.OC(CH₃)₂CH₂CH₃→Diamond.+(H or D)OC(CH₃)₂CH₂CH₃ (2)

Diamond.+.OC(CH₃)₂CH₂CH₃→Diamond-OC(CH₃)₂CH₂CH₃ (3)

While this mechanism surely has an element of truth in it, as set for the later, it can be argued that it is probably an oversimplification of what is occurring at the diamond surface. To wit, if peroxy radicals can abstract hydrogen from hydrogen-terminated diamond, they should also be able to abstract it from other chemisorbed peroxy fragments. This leads to the possibility of multilayer growth on diamond using DTAP.

DTAP, and other dialkyl peroxides, are potentially important reagents for diamond functionalization because of the robust C—O bond (ether linkage) that should be formed to tether DTAP fragments to diamond particles. Such stable adsorbates might be a useful addition to potential diamond stationary phases for chromatography, which are based on the high stability of diamond. Accordingly, we show the use of DTAP-functionalized diamond particles in solid phase extraction.

In spite of an earlier report to the contrary and a different attempt that appears to have been unsuccessful, here we show an improved method that allows functionalization of hydrogen- and deuterium-terminated diamond with a dialkyl peroxide. In particular, hydrogen-/deuterium-terminated diamond particles were treated with neat di-tert-amyl peroxide (DTAP, C₂H₅C(CH₃)₂OOC(CH₃)₂C₂H₅) at elevated temperature. Surface changes were followed by X-ray photoelectron spectroscopy (XPS), diffuse reflectance Fourier transform infrared spectroscopy (DRIFT), and time-of-flight secondary ion mass spectroscopy (ToF-SIMS). After these reactions, the oxygen signal in the XPS spectra increased, the deuterium peak in the negative ToF-SIMS spectra decreased, and DRIFT showed C—H stretches, which were not previously present, and which were similar to those of the precursor. In the C—H stretching region, the IR spectrum of adsorbed di-tert-amylperoxide shows features that are redshifted with respect to the IR spectrum of the precursor molecule. These trends are supported by DFT calculations. These data are consistent with chemisorption of fragments of di-tert-amylperoxide primarily through ether linkages. The threshold for this reaction was determined by DRIFT to be ca. 95° C. Multilayers of DTAP could be prepared by repeated exposure of the substrate to this reagent. Functionalized diamond particles were used in solid phase extraction.

### BRIEF DESCRIPTION OF DRAWINGS

FIG. 1: XPS survey spectra of diamond powders: (a) clean, untreated diamond particles (b) deuterium-terminated diamond particles and (c) deuterium-terminated diamond particles treated with di-tert-amyl peroxide for 1 day at 110° C.

FIG. 2: DRIFT spectroscopy for diamond powders: (a) raw, untreated diamond powder, (b) diamond particles after deuteration, (c) deuterium-terminated diamond particles treated with di-tert-amyl peroxide for 1 day at 130° C. and (d) the IR absorbance spectrum of neat di-tert-amyl peroxide. The positions of the dashed lines are 2966 and 2977 cm⁻¹.

FIG. 3: ToF-SIMS negative ion spectra of (a) clean, untreated diamond powder, (b) deuterium-terminated diamond particles (c) deuterium-terminated diamond particles treated with di-tert-amyl peroxide for 1 day at 110° C.

FIG. 4. DRIFT spectroscopy for deuterium-terminated diamond particles treated with di-tert-amyl peroxide for 1 day at different temperatures and the IR spectrum of neat di-tert-amyl peroxide. The positions of the dashed lines are 2965 and 2977 cm⁻¹.

FIG. 5. DRIFT spectroscopy for a) hydrogen-terminated diamond powder, b) hydrogen-terminated diamond particles treated with di-tert-amyl peroxide for 1 day at 130° C., c) neat di-tert-amyl peroxide. The positions of the dashed lines are 2962 and 2978 cm⁻¹.

FIG. 6. DRIFT spectroscopy (C—H and C—O stretching regions) for deuterium-terminated diamond particles treated with di-tert-amyl peroxide for 1 day at 120° C. for different numbers of reaction cycles with DTAP.

### DETAILED DESCRIPTION

### Example I

### Experimental

### Reagents

All chemicals were used as received. Toluene (spectra grade) and di-tert-amyl peroxide (97%) were obtained from Aldrich. The gas mixtures, including 5% deuterium in argon (99.999%) and 6% hydrogen in argon were purchased from Airgas, Inc. 1.7 μm and 70 μm diamond particles were provided by U.S. Synthetic Corp. (Orem, Utah).

### Preparation of Hydrogen-/Deuterium-Terminated Diamond Particles

Diamond particles were washed with an acid mixture (90% H₂SO₄+10% HNO₃) at 80° C. for 4 h and then rinsed with distilled water.³⁷ After drying in a tube furnace (Mini-Mite, Lindberg/Blue M, Model number TF55030A-1, Thermo Electron Corporation), clean diamond particles were treated in flowing 5% D₂ (6% H₂) gas at 900° C. in the same furnace for 28 h. (Caution: Hydrogen and deuterium gas may form explosive mixtures with air. A mixture of 5% D₂ (or 6% H₂) in Ar (or N₂) (forming gas) cannot be ignited and is potentially much safer.) During the reaction, the diamond particles were shaken twice to evenly deuterate (or hydrogenate) the surface and it was cooled in flowing 5% D₂ (or 6% H₂) in Ar. The resulting deuterium (or hydrogen)-terminated diamond particles were used as the starting point for this work.

Treatment of Hydrogen-/Deuterium-Terminated Diamond Particles with Di-tert-Amyl Peroxide

Hydrogen-/deuterium-terminated diamond particles (0.5 g) were suspended in neat di-tert-amyl peroxide (25 mL). Nitrogen gas was bubbled through the suspension to remove oxygen. Di-tert-amyl peroxide, C₂H₅C(CH₃)₂OOC(CH₃)₂C₂H₅, is a clear, colorless liquid. Suspensions were heated to 60, 80, 90, 95, 100, 110, 120, 130 or 150° C. for 24 h. For the 130° C. reaction, an additional 10 mL of DTAP was added after 10 hours of reaction to replace the peroxides that were consumed. For the 150° C. reaction, an additional 10 mL of DTAP was added two times (every 8 hours) during the reaction. The diamond powders were finally washed with toluene and dried in a vacuum dryer.

Multilayer Formation on Deuterium-Terminated Diamond Particles with Di-tert-amyl Peroxide

Deuterium-terminated diamond particles (0.5 g) were heated in neat di-tert-amyl peroxide (25 mL) under nitrogen gas at 120° C. for 24 h. A 10 mL volume of DTAP was added a second time after 10 h of reaction to replace the peroxides that were consumed. The diamond powders were washed with toluene and dried in a vacuum dryer. The entire process above was repeated to build multilayers of DTAP on the surface.

### Characterization of the Diamond Surfaces

Time-of-flight secondary ion mass spectrometry (ToF-SIMS) was performed with an ION-TOF ToF-SIMS IV instrument using monoisotopic 25 keV ⁶⁹Ga⁺ ions. X-ray photoelectron spectroscopy was performed with an SSX-100 X-ray photoelectron spectrometer with a monochromatic Al K_{α} source and a hemispherical analyzer. An electron flood gun was employed for charge compensation. Survey scans as well as narrow scans were recorded with an 800×800 μm spot. The diamond surface was characterized with a Magna-IR 560 spectrometer from Nicolet (Madison, Wis.). The DRIFT spectra were obtained over the range of 400-4000 cm⁻¹. For each spectrum, 64 scans were collected at a resolution of 4 cm⁻¹. Di-tert-amylperoxide was dissolved in CCl₄ and this solution was analyzed by transmission IR in a static liquid cell. Both the diffuse reflectance and transmission data were plotted in Kubelka-Munk units.

### Solid Phase Extraction (SPE) Column Packing and Elution Procedure

The packing material from a commercially-available SPE cartridge was replaced with the functionalized diamond to act as a stationary phase. The same volume (ca. 5.0 cm³) of packing material was used in each of the experiments. To improve packing, the cartridges were washed with methanol under reduced pressure from the house vacuum during loading. Finally, the columns were dried using the house vacuum.

Prior to applying the analyte, cyanazine, the column was conditioned with 6 column volumes of methanol, followed by 6 column volumes of water. A 30 or 100 μL volume of cyanazine in water (10.8 μg/mL) was loaded onto the column. The column was then washed with water and finally eluted with methanol. Such columns could be reused multiple times in this fashion after washing with methanol.

### Breakthrough Curves and Column Capacity

The columns containing diamond powder functionalized with either a monolayer or four multilayers of di-tert-amyl peroxide were first conditioned using the procedure mentioned above. After conditioning, the solutions of cyanazine in water (0.1 and 0.3 μg/mL) were passed through both SPE columns, respectively, at a constant flow rate. Equal volumes (fractions) eluting from a column were collected in separate vials. Finally, these fractions were analyzed by ESI-MS.

Breakthrough curves, which generally have sigmoidal shapes, are plots of analyte concentration (corresponding to the [M+1]⁺ peak area of the analyte in each fraction) vs. solution volume eluted from the column. The breakthrough volume was calculated from the point on the curve corresponding to 5% of the average value at the maximum (the plateau region). The column capacity was calculated by multiplying the breakthrough volume by the corresponding concentration of analyte.

### Electrospray Mass Spectrometry (ESI-MS)

ESI-MS was performed using an Agilent Technologies LC/MSD TOF system by direct infusion of several μLs of sample along with the mobile phase: 75% MeOH and 25% water, with 5 mM ammonium formate. A steel ES ionization needle was set in positive-ion mode, and the charging voltage and the capillary voltages were set at 900 V and 3500 V, respectively. The nebulizer was set at 35 psi, the gas temperature was 350° C., and the skimmer was operated at 60 V. The flow rate of the nitrogen drying gas was 12 L/min. One survey scan was collected per second over a mass range of m/z 100-1200.

### Density Functional Theory (DFT) Calculations

Analysis of the vibrational modes was carried out using B3LYP density functional theory (DFT) with a 3-21 G basis set using the NWChem program.^{38, 39}

### Results and Discussion

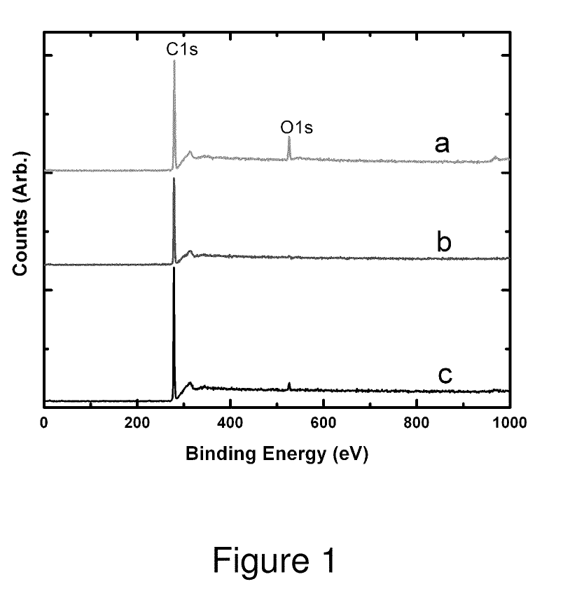

X-ray photoelectron spectroscopy (XPS) was used to study the formation of deuterium-terminated diamond and its subsequent reaction with DTAP. FIG. 1a shows clean, untreated diamond particles that contains an obvious oxygen signal, (10.1±0.4% oxygen, 89.9±0.4% carbon), which is presumably due to oxidized carbon at the diamond surface. After the diamond particles are treated in 5% D₂ in Ar, XPS shows a significant reduction in the oxygen signal (See FIG. 1b) (0.9±0.05% oxygen, 99.1±0.1% carbon). (The material compositions given in this paragraph were obtained from XPS narrow scans.)

After deuterium-terminated diamond particles were exposed to heated di-tert-amyl peroxide for 1 day, the XPS oxygen signal rose (3.1±0.6% oxygen, 96.9±0.6% carbon), but not to the level found before deuterium termination (See FIG. 1c). This increase in surface oxygen is consistent with the chemisorption of radical fragments of DTAP, as given in Step 3 of the mechanism (vide supra).

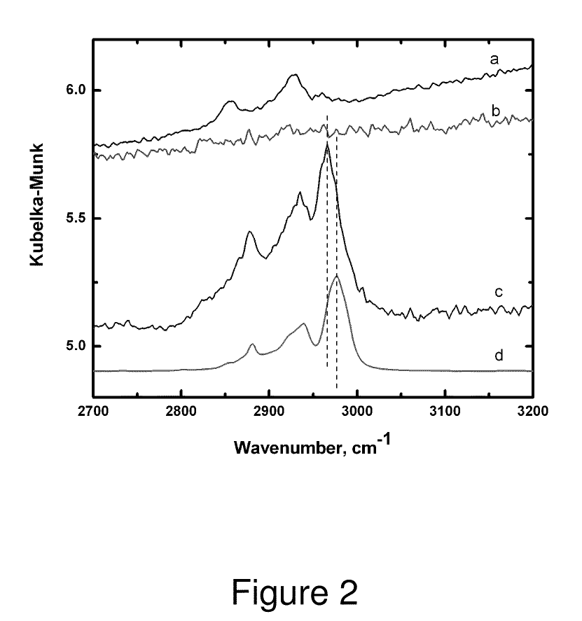

FTIR was also used to characterize diamond particles as they were received, after deuterium termination, and after reaction with DTAP (See FIG. 2). FTIR of the as-received diamond particles shows evidence of hydrocarbon contamination in the C—H stretching region at ca. 2800-3000 cm⁻¹. (FIG. 2a is very similar to the IR spectrum obtained by Liu after his “reaction” with DTAP³⁵). After treatment with D₂ gas, these stretches almost entirely disappear, and following treatment with DTAP, a series of stretches reappear in the C—H stretching region that are similar to those in DTAP-modified diamond, suggesting that DTAP fragments are covalently bonded to the diamond surface.

While the IR spectra of adsorbed fragments of di-tert-amylperoxide and that of the DTAP molecule itself are similar, there is an interesting difference between the spectra, which is that the largest peak in the spectrum of the functionalized diamond is redshifted by ca. 10 cm⁻¹ relative to the largest peak in the spectrum of the DTAP. Accordingly, DFT was used to model both DTAP and perdeuterated adamantine that had been monofunctionalized with a fragment of DTAP at both possible positions, as shown in Scheme 2. Adamantine is a diamondoid and should be a reasonable model system for our diamond surfaces. All positions on adamantane were deuterated in the simulation so that the frequencies in the C—H stretching region would be uniquely separated from those of the adsorbate. The results of the DFT modeling shown in Table 1, which are presented without scaling, are in good agreement with the experimental results with a standard scaling factor of 0.96 for this level of theory. The frequencies of the C—H normal modes in both DTAP, and the DTAP fragment attached to an adamantine ring show that vibrational frequencies of the DTAP fragment on the adamantine substrate are redshifted, with the highest frequency peaks at 3152, 3149 and 3137 cm⁻¹ not appearing in the spectrum of the chemisorbed species. This is in agreement with the measured DRIFT spectrum, which shows a similar redshift.

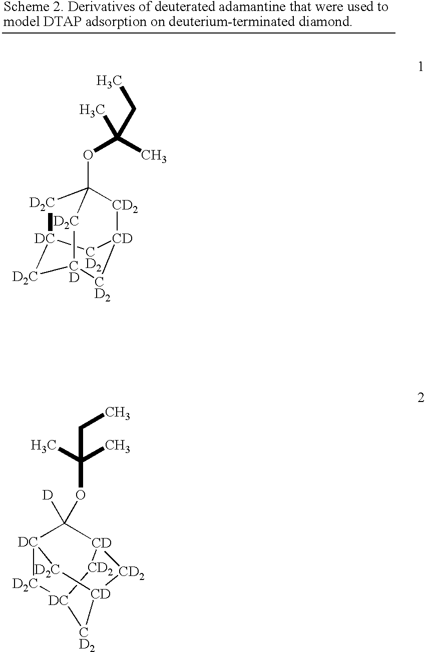

TABLE 1
Measured and calculated C—H stretching frequencies for DTAP
and DTAP fragments attached to the secondary and tertiary
carbon sites of adamantine, showing the redshift of the DTAP
fragment when chemisorbed. DFT frequencies are calculated
with B3LYP/6-31 + G*, and are unscaled.

| di-tertamyl | | Chemisorbed Secondary Tertiary | | |
|---|---|---|---|---|
| peroxide | | species | | |
| Measured | | Measured | | |
| (cm⁻¹) | DFT (cm⁻¹) | (cm⁻¹) | DFT (cm⁻¹) | DFT (cm⁻¹) |
| 2977 | 3152, 3149, | 2966 | 3128, 3123, | 3131, 3128, |
| | 3137, 3132, | | 3121, 3115, | 3124, 3120, |
| | 3127, 3125, | | 3112 | 3115 |
| | 3124, 3120, | | | |
| | 3113, 3112 | | | |
| 2940 | 3103, 3099, | 2935 | 3102 | 3100, 3095 |
| | 3091 | | | |
| 2881 | 3067, 3061, | 2881 | 3071, 3057, | 3060, 3056, |
| | 3057, 3054, | | 3049, 3046, | 3052, 3050, |
| | 3051, 3048, | | 3037 | 3044 |
| | 3047, 3044, | | | |
| | 3025 | | | |

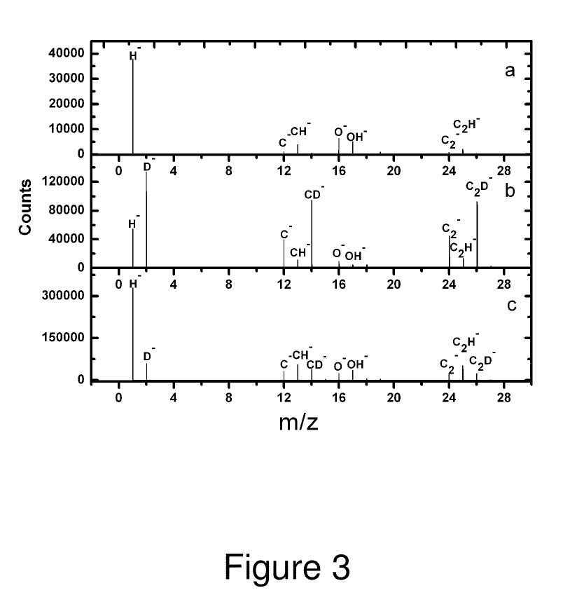

DRIFT of diamond particles show a series of substrate peaks that overlap with the C-D stretches,²² making this region (1600-2600 cm⁻¹) of the spectrum of questionable value for this analysis. XPS was not useful for identification of H (or D), as it is not sensitive to hydrogen. ToF-SIMS can detect every element, and it provides direct evidence for surface deuteration in both positive and negative ion spectra. In the negative ion ToF-SIMS spectrum, a strong H⁻ signal is seen in the untreated diamond particles (See FIG. 3a). This signal is consistent with the C—H stretches in the FTIR spectrum. Following surface deuteration, strong signals due to D⁻, CD⁻, and C₂D⁻ appear in the negative ion spectrum (See FIG. 3b). This spectrum also contains a reasonably large H⁻ signal, which is consistent with the very low level of C—H stretches that still appears to be in the FTIR spectrum of deuterated diamond (just above the noise level, and presumably due to chemisorbtion of adventitious hydrocarbons after surface deuteration—hydrocarbons would not survive the conditions of diamond deuteration we employed). Because of its very low penetration depth (ca. 2 nm), ToF-SIMS is extremely sensitive to surface contamination. After surface reaction with DTAP, the H⁻ signal regains its prominence, although some D⁻ remains, suggesting that the surface reaction was incomplete (See FIG. 3c).

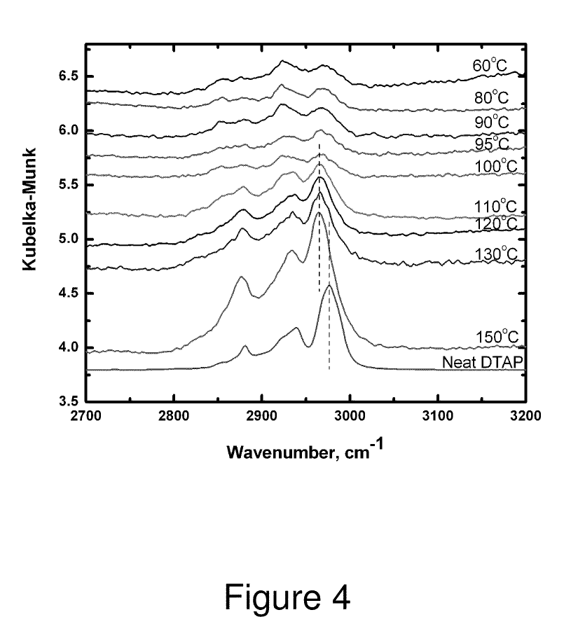

Because of previous attempts to modify diamond with di-t-butylperoxide or dicumylperoxide and DTAP (at 85° C. or 112° C., respectively), it seemed appropriate to understand the relationship between degree of surface functionalization and reaction temperature. Below 90° C., FIG. 4a-c shows no obvious spectral changes in the DTD treated with DTAP that would suggest surface functionalization. However, at 95° C., the C—H stretching envelope shows a series of low intensity features that begin to resemble those of neat DTAP. The spectrum at 100° C. is essentially the same as that at 95° C. At 110° C., these features are more pronounced and suggest more effective surface functionalization. Surface functionlization appears to take place even more effectively at 130° C. and then to an even greater extent at 150° C.

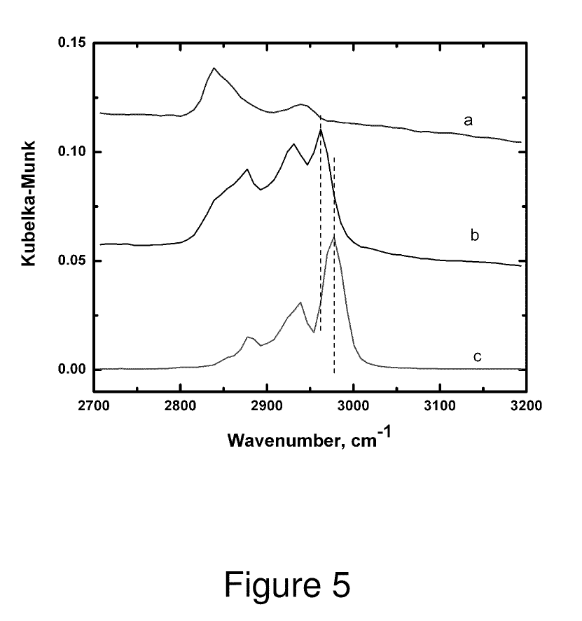

Because, as noted, a series of peaks that are characteristic of diamond²² overlap with the C-D stretches around 2100 cm⁻¹, it seemed appropriate to also follow the reaction of hydrogen-terminated diamond and DTAP. Results analogous to those obtained with deuterium-terminated diamond are obtained. After hydrogenation, two peaks are present between 2800 and 3000 cm⁻¹ (See FIG. 5a), which have previously been observed on hydrogen-terminated diamond.²⁷ After the reaction, the C—H stretching vibrations are similar to those of neat DTAP, with added contributions from the HTD surface. These results are consistent with the incomplete surface reaction suggested by the ToF-SIMS results in FIG. 3.

It should also be mentioned that the redshift noted in FIG. 2 appears to be present in the spectra of the treated HTD (FIG. 5), and in the temperature study shown in FIG. 4. Indeed, we attempted to fit the spectrum of the DTAP-treated HTD with the spectra in FIGS. 5a and 5c. The resulting classical least squares treatment showed a poor fit, especially at the high energy end of the C—H envelope.

It is doubtful that the reaction of hydrogen- or deuterium-terminated diamond could be driven to completion because of steric hindrance of DTAP fragments adjacent to surface C-D or C—H groups. There is also the possibility of H-abstraction from chemisorbed DTAP fragments competing with hydrogen or deuterium abstraction from the surface. Based on the mechanism proposed above, it should also be possible for peroxy radicals to attack the methylene units of chemisorbed fragments of DTAP. If operative, this procedure could be repeated several times and multilayers could be grown on the diamond surface. This proposed mechanism is as follows:

Diamond-OC(CH₃)₂CH₂CH₃+.OC(CH₃)₂CH₂CH₃→Diamond-OC(CH₃)₂CH.(CH₃)+HOC(CH₃)₂CH₂CH₃ (4)

Diamond-OC(CH₃)₂CH.(CH₃)+.OC(CH₃)₂CH₂CH₃→Diamond-OC(CH₃)₂CH(CH₃)OC(CH₃)₂CH₂CH₃ [symbol] Diamond-(OC(CH₃)₂CH(CH₃))ₙ—H (5)

An implication of this mechanism is that polymer brushes of the form: diamond-(OC(CH₂)₂CH(CH₃))ₙ—H could be formed, as illustrated in the table-of-contents graphic for this work.

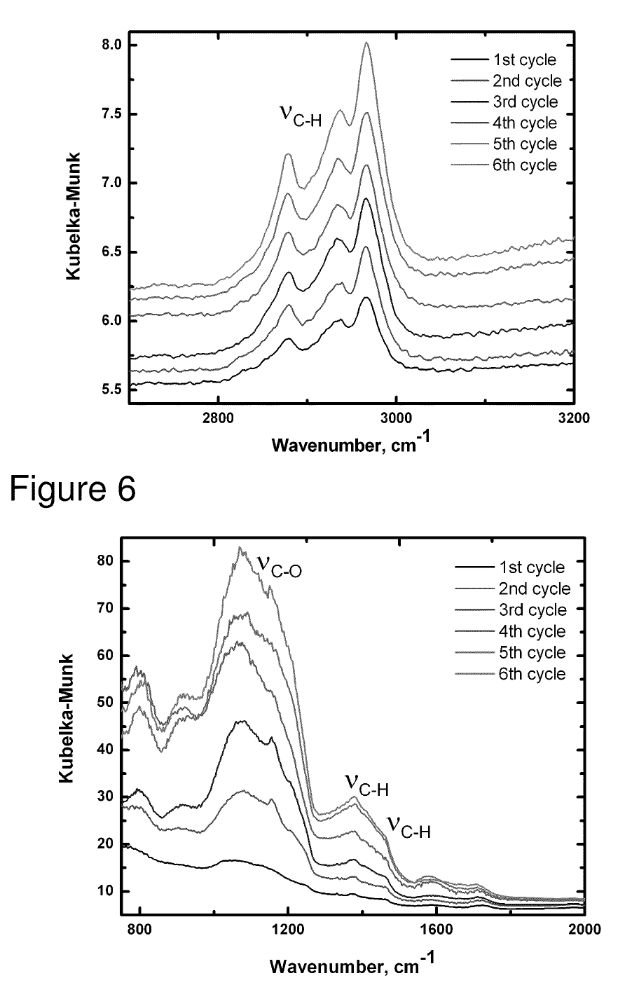

FIG. 6 shows the C—H and C—O stretching regions of diffuse-reflectance FTIR spectra of diamond that was repeatedly treated with neat di-tert-amyl peroxide. Bands at 2800-3100 cm⁻¹ are assigned to the C—H stretches, and bands at 1350 and 1450 cm⁻¹ are due to C—H bends. The band at ca.1100 cm⁻¹ is assigned to the C—O stretch. These peaks increase in intensity with increasing numbers of reaction cycles of DTAP. The spectra also suggest that a small number of carbonyl groups are formed, suggesting additional complexity in the mechanism. A plot of the peak area, A, of the C—H stretching regions vs. the number of reaction cycles produces a plot (see Supporting Information) that shows a monotonic increase in peak area with reaction cycle, and that can be fit to a straight line: A=15.94*n+37.58, where n is the number of layers, with an R² value of 0.90. These results are consistent with the hypothesis of multilayer growth on diamond surfaces from DTAP. Further evidence for the possibility of polymerization of DTAP-derived layers on diamond is that studies of DTAP thicken after heating.

This same procedure of multilayer growth was applied to 70 μm hydrogen-terminated diamond particles, which because of back pressure constraints are an appropriate size for solid phase extraction. The columns were first conditioned and then a solution of cyanazine, a pesticide, was loaded onto the column. The column was washed with water and the analyte was eluted with methanol. Electrospray ionization mass spectrometry (ESI/MS) was used to confirm the presence or absence of the analytes in the fractions that were taken. From the ESI-MS results, the [M+1]⁺ peak at 241 amu of the analyte (cyanazine) appeared in the methanol fraction, while nothing eluted in the pre-wash. Breakthrough curves were obtained for SPE columns using cyanazine as an analyte to determine breakthrough volumes of the SPE columns (diamond particles functionalized with either a monolayer or four multilayers of di-tert-amyl peroxide). Columns prepared from the diamond stationary phase made with one cycle of DTAP were compared to columns made with four cycles of DTAP. The latter column had 4-5 times the analyte capacity of the first column. These results are clearly consistent with the formation of a polymeric material on the stationary phase.

### CONCLUSIONS

Although there are reports to the contrary, XPS, ToF-SIMS and DRIFT demonstrate the reactivity of DTD and HTD with a neat dialkylperoxide (di-tert-amyl peroxide) at elevated temperature. After reaction, XPS showed that the oxygen signal increased, and the deuterium peak in the negative ion ToF-SIMS spectra decreased. DRIFT showed that the envelopes of the C—H stretch of the adsorbate and the surfaces are similar after modification, although it is significant that the peak envelope of the C—H stretching region of the functionalized diamond is redshifted with respected to that of the precursor. The threshold for the reaction is determined, and multilayer formation is illustrated with several reaction cycles. Solid phase extraction could be performed on columns packed with DTAP-functionalized diamond particles.

What is claimed is:

1. A method of forming a surface on diamond comprising:
terminating a diamond surface with hydrogen or deuterium;
reacting the hydrogen or deuterium-terminated diamond particle with a dialkyl or diaryl peroxide.

2. A method of forming a surface on diamond comprising:
terminating the surface with hydrogen or deuterium;
reacting the hydrogen or deuterium-terminated diamond particle with a dialkyl or diaryl peroxide,
R—O—O—R′
where R and R′ are the same or different, R and R′ are alkyl, or aryl, and where neither or one is hydrogen,
the reacting under to thermally decompose the peroxide to peroxy fragments in the form of reactive radicals in sufficient concentration to abstract hydrogen or deuterium and to bond peroxy fragments to carbon on the diamond surface.

3. A method as in claim 2 wherein the reacting is under conditions above about 95° C.

4. The method of claim 2 wherein the peroxy fragments are also bonded to carbon in peroxy fragments bonded on the diamond surface.

5. A method as in claim 1 wherein the diamond surface is of a diamond particle, or a planar diamond surface.

6. A method as in claim 2 wherein one or both of R and R′ contains elements besides carbon and hydrogen.

7. A method as in claim 1 wherein the reacting the hydrogen or deuterium-terminated diamond particle with a dialkyl or diaryl peroxide is repeated one or more times to thicken the coating upon the diamond surface by bonding further peroxy fragments to previously bonded peroxy fragments.

8. A method of conducting a chromatographic separation comprising;
passing an analyte through a stationary phase comprising diamond particles coated with a dialkyl or diaryl peroxide, the diamond particles coated by:
terminating a diamond surface with hydrogen or deuterium;
reacting the hydrogen or deuterium-terminated diamond particle with a dialkyl or diaryl peroxide.

9. The method of claim 8 wherein the chromatographic separation is high performance liquid chromatography (HPLC), ultra high performance liquid chromatography (UPLC), solid phase extraction, gas chromatography, electrochromatography.

10. The method of claim 8 wherein the chromatographic separation occurs in a microfluidic devices.

11. A coated diamond surface comprising peroxy fragments bonded to carbon, wherein the peroxy fragments are the decomposition product of a dialkyl or diaryl peroxide.

12. A diamond surface comprising peroxy fragments bonded to carbon, wherein the peroxy fragments are the decomposition product of a dialkyl or diaryl peroxide, the peroxide represented by;
R—O—O—R′
where R and R′ are the same or different, R and R′ are alkyl, or aryl, and where neither or one is hydrogen.

13. A diamond surface as in claim 11 wherein the surface is of a diamond particle or a diamond planar surface.

14. A diamond surface as in claim 12 wherein one or both of R and R′ contains elements besides carbon and hydrogen.

15. A diamond surface as in claim 11 wherein the peroxy fragments are bonded to carbon within peroxy fragments.
